(19) United States
(12) Patent Application Publication
(10) Pub. No.: US 2010/0032864 A1
(43) Pub. Date: Feb. 11, 2010

(54) Process for Manufacturing a Pneumatic Tyre, Related Manufacturing Line and Assembling Apparatus

(75) Inventors: Maurizio Marchini, Milano (IT); Fiorenzo Mariani, Milano (IT); Pierangelo Misani, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI TYRE S.P.A., Milano (IT)

(21) Appl. No.: 12/311,432

(22) PCT Filed: Oct. 12, 2006
(86) PCT No.: PCT/EP2006/009872

§ 371 Date: Mar. 30, 2009

(51) Int. Cl. B29C 65/02

(52) U.S. Cl. 264/241; 156/396

(57) ABSTRACT

A process and a tyre manufacturing line for producing tyres, wherein the process includes the steps of: i) transferring a first toroidal support to a first assembling apparatus; ii) in the first assembling apparatus, sequentially building on the first toroidal support a first toroidal carcass ply and a first pair of annular reinforcing inserts so as to associate each annular reinforcing insert with a respective radially internal edge of the first toroidal carcass ply; iii) transferring the first toroidal support to a second assembling apparatus; iv) in the second assembling apparatus, sequentially building on the first toroidal support, carrying the first toroidal carcass ply associated with the first pair of annular reinforcing inserts, a second toroidal carcass ply and a second pair of annular reinforcing inserts so as to associate each annular reinforcing insert with a respective radially internal edge of the second toroidal carcass ply.

### BACKGROUND OF THE INVENTION

The present invention relates to a producing process of a pneumatic tyre and to the relevant building line and assembling apparatus.

In particular, the present invention relates to a process for producing a pneumatic tyre, to the relevant building line and to an assembling apparatus of a working station of the building line for assembling a carcass structure.

### RELATED ART

Modern tyre manufacturing plants comprise a building line, wherein the different components of the tyre are made and/or assembled to form a green tyre, and a molding and vulcanization line wherein the tyre structure is defined and the tyre is completed.

A tyre generally comprises a toroidally ring-shaped carcass including one or more carcass plies, strengthened with reinforcing cords, lying in substantially radial planes, (a radial plane contains the rotation axis of the tyre). Each carcass ply has its ends integrally associated with at least one metal annular anchoring structure, usually known as bead core, constituting the reinforcing at the beads, i.e. at the radially internal ends of the tyre, the function of which is to enable assembling of the tyre with a corresponding mounting rim. Each of said anchoring structures is usually made up of a substantially circumferential annular insert onto which at least one filling insert is applied, at a radially external position thereof. Placed crown wise to said carcass structure is a band of elastomer material, called tread band, in which, at the end of the vulcanization and molding steps, a raised pattern is formed for ground contact. A reinforcing structure usually known as belt structure is placed between the carcass and the tread band. In the case of car tyres, this structure usually comprises at least two radially superposed strips of rubberised fabric provided with reinforcing cords, generally of metal material, positioned parallel to each other in each strip and in a crossed relationship with the cords of the adjacent strip preferably symmetrically arranged with respect to the equatorial plane of the tyre. Preferably said belt structure further comprises at a radially external position thereof, at least on the ends of the underlying strips, also a third layer of textile or metallic cords, circumferentially disposed (at zero degrees).

Finally, in tyres of the tubeless type, i.e. devoid of an air tube, a radially internal layer, called liner, is present which has imperviousness features to ensure the air-tightness of the tyre.

To the aims of the present description as well as in the following claims, by the term “elastomer material” it is intended a composition comprising at least one elastomer polymer and at least one reinforcing filler. Preferably this composition further comprises additives such as cross-linking and/or plasticizing agents. By virtue of the cross-linking agents, this material can be cross-linked through heating so as to form the final manufactured article.

Moreover, in the present description and in the following claims, by the term “carcass structure” it is intended a structure comprising at least one carcass ply and one annular insert.

According to recently developed tyre manufacturing processes, tyres are produced starting from a limited number of elementary semifinished products fed onto a toroidal support whose outer profile coincides with that of the radially internal surface of the tyre that is wished to be produced. Said toroidal support is moved, preferably by means of a robotized system, among a plurality of working stations in each of which, through automated sequences, a particular building step of the tyre is carried out.

For example, the International Patent Application WO 01/39963, in the name of the same Applicant, discloses a plant for producing different types of tyre comprising a complex manufacturing unit having a plurality of working stations, each designed to assemble at least one corresponding structural component on at least one type of tyre being processed, a complex vulcanizing unit and devices for the functional transfer of the tyre being processed, operating between the working stations.

The International Patent Application WO 01/32409, in the name of the same Applicant, discloses a manufacturing line provided with working stations, each arranged to make and assemble at least one structural component of the tyre being processed. Said structural components are assembled on a toroidal support provided with bar codes through which the model of the tyre to be manufactured is identified and consequent adaptation of the working stations to the particular tyre working is carried out. Robotized arms sequentially transfer the individual tyres between the different working stations and to a curing line.

The development of new technologies and the necessity of high performance tyres, have oriented the production towards more complex products such as tyres with multiple carcass plies and corresponding multiple reinforcing structures.

An example of said tyres is described in WO 00/26014, in the name of the same Applicant, which discloses a tyre carcass structure comprising two carcass plies each made up of a first and a second series of strip-like sections laid down on the toroidal support in alternate sequence. Also arranged in each tyre bead is a pair of annular reinforcing structures inserted between the end flaps of the sections belonging to the first and second series respectively and forming one of the carcass plies.

In order to obtain multiple carcass ply tyres, the known production processes, among which the processes disclosed in the above mentioned patent applications, comprise repeated transferals of the processed tyre between a first working station intended for laying down the strip-like elements forming the carcass ply and a second working station intended for laying down the annular inserts forming the tyre beads.

### SUMMARY OF THE INVENTION

These repeated transfers of the toroidal support moving forward and backward between the same working stations are notably time-consuming and decrease the productive capacity of the tyre production plant.

Moreover, the processes above described do not allow a well-managed utilization of the different working stations and devices of the tyre building line.

The Applicant has perceived that by repetitively transferring the toroidal support between the bead working station and the ply working station, the handling time of the toroidal support is badly managed since it moves along a forward-backward pathway that results long and time-consuming.

The Applicant has therefore noted that by decreasing the number of transferring steps of the toroidal support in the tyre building process and, in particular, by moving the toroidal support sequentially from one working station of the building line to the following, along a unidirectional pathway, it is possible to achieve a simpler process which allows to increase the productive capacity of the tyre manufacturing plant while maintaining constant the quality of the final products.

The Applicant has also noted that by integrating a device for assembling annular inserts and a device for assembling carcass plies in a single apparatus it is possible to avoid useless transferring operation, decreasing in this way the tyre manufacturing time and thus the production cost per piece.

The Applicant has further found that by providing the known tyre manufacturing plants with a tyre building line comprising one or more apparatuses adapted for assembling both the carcass plies and the corresponding annular inserts on the toroidal support, it is possible to simplify the manufacturing processes while increasing the productive capacity of the manufacturing plants.

Therefore the present invention provides a tyre producing process which allows to achieve a minimum number of transferring steps so as to increase the productive capacity of the tyre manufacturing plant without decreasing the quality of the final tyre.

Alternatively the present invention provides an apparatus and a tyre building line which allow to achieve the minimum transferring operations of the toroidal support and a better management of the tyre being processed thereon, with a consequent increase of the productive capacity.

The Applicant has found that both the hereinabove objects are achieved by decreasing the number of transferring steps of the toroidal support in the tyre building process of a tyre manufacturing plant through the use of an apparatus adapted for assembling both the annular inserts and the carcass plies on the toroidal support. In this way, it is possible to simplify the manufacturing process and to increase the productive capacity, by means of a well-managed handling of the toroidal support.

According to a first aspect, the invention relates to a process for producing tyres, said tyres having a carcass structure comprising at least two carcass plies, each carcass ply being associated with at least a pair of annular reinforcing inserts, the process comprising the following steps:

i) transferring a first toroidal support to a first assembling apparatus;
ii) in the first assembling apparatus, sequentially building on the first toroidal support a first toroidal carcass ply and a first pair of annular reinforcing inserts so as to associate each annular reinforcing insert to a respective radially internal edge of the first toroidal carcass ply;
iii) transferring the first toroidal support to a second assembling apparatus;
iv) in the second assembling apparatus, sequentially building on the first toroidal support, carrying the first toroidal carcass ply associated with the first pair of annular reinforcing inserts, a second toroidal carcass ply and a second pair of annular reinforcing inserts so as to associate each annular reinforcing insert to a respective radially internal edge of the second toroidal carcass ply;
v) transferring a second toroidal support to the first assembling apparatus to build thereon a respective first toroidal carcass ply associated to a respective first pair of annular reinforcing inserts;
vi) completing the building of the tyre on said first toroidal support;
vii) repeating the steps iv) and vi) on said second toroidal support;
viii) moulding and vulcanizing the built tyres;
wherein the step v) of transferring the second toroidal support to the first assembling apparatus is carried out when the first toroidal support is processed in the second assembling apparatus during the step iv).

Preferably the process of the invention further comprises, between step ii) and step iv), the step of applying a first filler material on the first toroidal support carrying the first toroidal carcass ply associated with the first pair of annular reinforcing inserts.

Step vi) of completing the building of the tyre may comprises applying a second filler material on the first toroidal support carrying the second toroidal carcass ply associated with the second pair of annular reinforcing inserts.

According to another aspect the invention relates to a tyre building line including at least one working station for assembling a carcass structure, said working station comprising:
at least two assembling apparatuses of said carcass structure, each assembling apparatus including:
   at least one strip laying device adapted to lay a plurality of strip-like elements on side and crown portions of a toroidal support in order to form a carcass ply;
   at least one annular reinforcing insert laying device adapted to lay a plurality of coils of a first elongated element on at least one radially inner side of the toroidal support in order to form an annular reinforcing insert;
   at least one transferring device to carry out at least one transferring step of the toroidal support selected from:
      (i) a transferring step from the building line into the working station;
      (ii) a transferring step inside the working station; and
      (iii) a transferring step from the working station to the building line.

Advantageously said working station comprises two transferring devices. In this way the functions to be performed are divided between a first and a second transferring device which are, therefore more dynamic, rapid and allow a better handling of the toroidal support.

Preferably said working station comprises one or more filler applying devices adapted to lay a plurality of coils of a second elongated element on at least one radially inner side of the toroidal support in order to form a filling insert structure.

According to a further aspect the invention relates to an assembling apparatus for assembling at least a portion of a carcass structure, comprising:
at least one strip laying device adapted to lay a plurality of strip-like elements on side and crown portions of a toroidal support in order to form a carcass ply;
at least one annular reinforcing insert laying device adapted to lay a plurality of coils of a first elongated element on at least one radially inner side of the toroidal support in order to form an annular reinforcing insert;
at least one positioning device adapted to operatively position the toroidal support alternately at the strip laying device and at the annular reinforcing insert laying device.

Advantageously said positioning device comprises a sliding element.

Preferably said assembling apparatus comprises at least one cutting device adapted for cutting said strip-like elements.

### BRIEF DESCRIPTION OF THE FIGURES

Further characteristics and advantages of the invention will be more apparent from the following description of one preferred embodiment of the tyre producing process, building line and assembling apparatus according to the invention, provided as a non-limiting example, with reference to the appended drawings wherein:

FIG. 1 shows a schematic lay-out of a tyre manufacturing plant wherein the process according to the invention is carried out

FIG. 2 shows a partial plan view of a tyre building line according to one preferred embodiment of the invention;

FIG. 3 shows a front view of an assembling apparatus belonging to a working station of the tyre building line according to one preferred embodiment of the invention; and

FIG. 4 shows the A-A cross sectional view of FIG. 2.

### DETAILED DESCRIPTION OF THE PREFERRED EMBODIMENTS

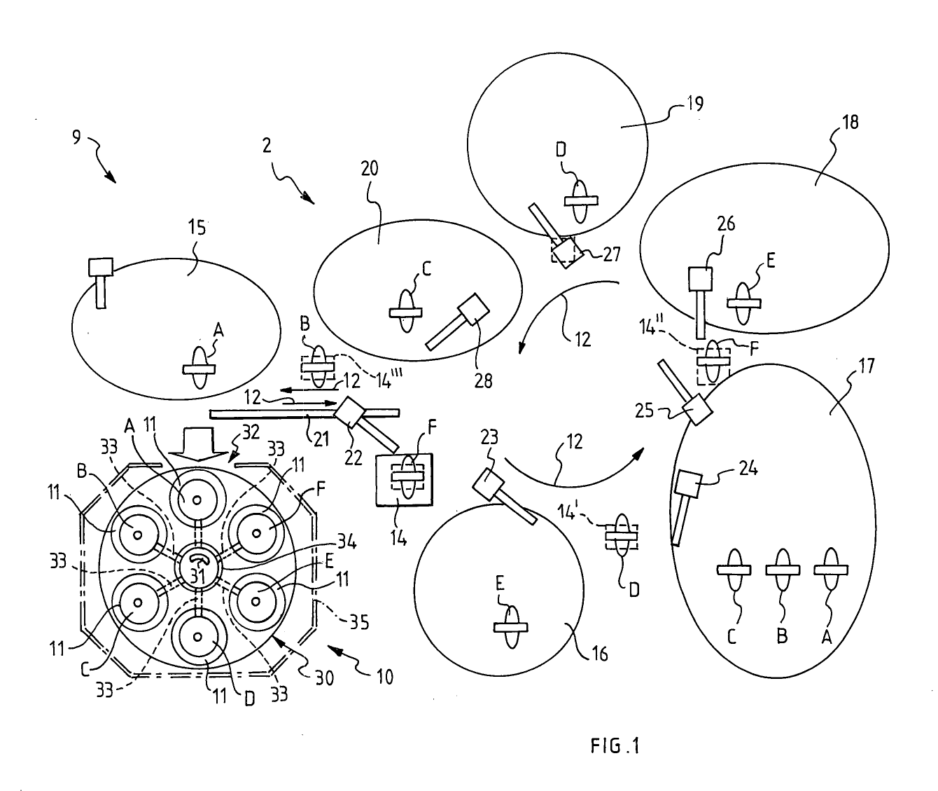

With reference to FIG. 1 by reference numeral 9 has been generally identified a tyre manufacturing plant wherein the process for producing tyres according to the present invention is carried out.

The tyre manufacturing plant 9 essentially comprises a building line 2 on which each tyre being processed is manufactured by assembling structural components of said tyre in a pre-established sequence, and a vulcanizing line 10 on which each tyre from the building line 2 is moulded and vulcanized within a respective mould 11.

In the tyre building line 2 the different components of the tyre are made and/or assembled to form a green tyre with multiple carcass plies and corresponding multiple annular inserts.

Said building line 2 essentially comprises a plurality of working stations 15, 16, 17, 18, 19, 20 disposed after each other along a manufacturing path, preferably in the form of a closed loop and represented, just as an indication, by arrows 12 in the drawing.

The working stations 15, 16, 17, 18, 19, 20 lend themselves to operate simultaneously, each on at least one tyre being processed for assembling at least one of its structural components thereon.

In more detail, during the assembling steps, the different structural components employed in making each tyre A, B, C, D, E, F are conveniently engaged on a support member, preferably consisting of a toroidal support the shape of which substantially matches the inner conformation of the tyre to be obtained. This toroidal support is preferably of the collapsible type or it is adapted to be divided into a plurality of sectors, so that it can be easily removed from the tyre when processing is over.

Transport devices 22, 23, 24, 25, 26, 27, 28 operate on the building line 2 to sequentially transfer each of the tyres being processed A, B, C, D, E, F from one working station 15, 16, 17, 18, 19, 20, to the next working station, so as to cause sequential assembling of all tyre components, said tyre being then transferred to the vulcanizing line 10.

Preferably, these transport devices 22, 23, 24, 25, 26, 27, 28 comprise one or more robotized arms each of which is associated with at least one of the working stations 15, 16, 17, 18, 19, 20 and is adapted to operate on the individual toroidal supports A, B, C, D, E, F to carry out sequential transfer of each tyre being processed.

More particularly, in the embodiment shown, a first robotized arm 22 is provided which is possibly movable along a guide structure 21 and operates between the building line 2 and vulcanizing line 10, to pick up a finished tyre from the latter and transfer it to a first working station 15, where the tyre is removed from the respective toroidal support A through disassembling of said support. In the first working station 15, the toroidal support A is subsequently reassembled to be then transferred, still by the first robotized arm 22, to a first stand-by station 14 from which it will be picked up for subsequent use in the manufacture of a new tyre.

A second robotized arm 23 lends itself to carry out transfer of the toroidal support F from the first stand-by station 14 to a second working station 16 where assembling of the first components for tyre construction is carried out. The assembling operation may, for example, involve coating of the outer surface of the toroidal support E with a thin layer of elastomer material impervious to air, usually called “liner”, as well as application of optional elastomer bands close to the regions corresponding to the tyre beads, and/or formation of an additional coating layer of elastomer material, placed on top of the liner.

Preferably each of the working stations 15, 16, 17, 18, 19, 20 is provided with one or more feeding devices adapted to supply the required base element for accomplishment of the corresponding structural component and operating in combination with application devices for applying the base element and/or the obtained structural component to the tyre being processed.

When assembling of the components in the second working station 16 has been completed, the second robotized arm 23 lays down the toroidal support with the respective tyre which is being manufactured in a second stand-by station 14′ that in the figure is occupied by toroidal support D, previously processed in the second station 16 itself.

A third robotized arm 24 picks up the toroidal support D from the second stand-by station 14′ to transfer it to a third working station 17.

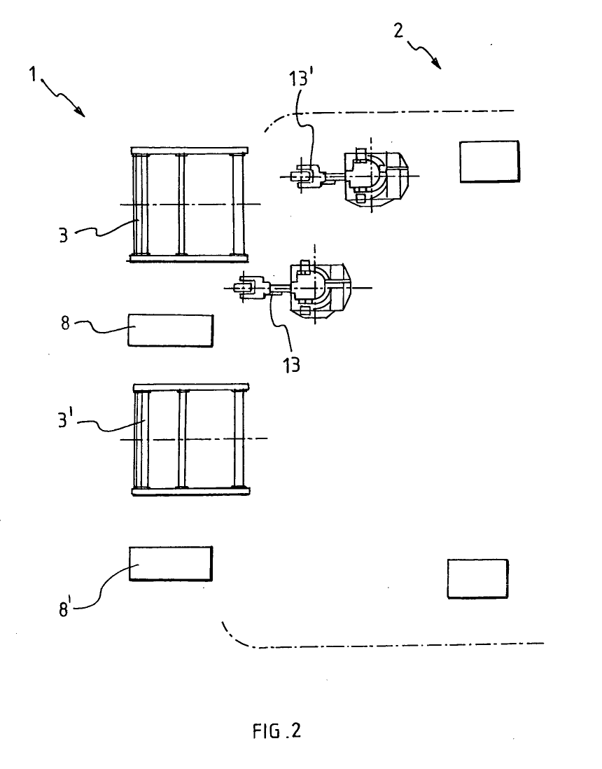

According to a preferred embodiment, said third working station 17, comprises a working station 1, shown in more detail in FIG. 2, adapted for assembling a carcass structure of a tyre, i.e. a structure comprising at least one carcass ply and one annular insert.

According to the present embodiment, the building line 2 includes one working station 1, however two or more working stations 1 may be provided in a building line 2 of a tyre manufacturing plant 9.

Each working station 1 comprises two or more assembling apparatuses 3, 3′, adapted for assembling at least a portion of the carcass structures of the tyres to be manufactured, and a first transferring device 13, adapted for transferring the toroidal support whereon the tyre is being built.

In particular, said first transferring device 13 is adapted to perform three main functions:
to move the toroidal support from the building line 2 into the working station 1 before the carcass building process is started;
to move the toroidal support inside the working station 1 from one assembling apparatus 3, 3′ to the other; and
to move the toroidal support from the working station 1 to the building line 2 where the building process is completed.

Optionally, each working station 1 of the tyre building line 2 comprises a second transferring device 13′ adapted to cooperate with the first transferring device 13.

Preferably the first transferring device 13 comprises a robotized arm. More preferably also said second transferring device 13′ comprises a robotized arm.

According to a variation of the invention, the working station 1 may comprise a third transferring device adapted to move the toroidal support from the working station 1 to the building line 2. Preferably said third transferring device comprises a robotized arm.

The working station 1 comprises at least one filler applying device 8, 8′ adapted to lay a plurality of coils of a second elongated element on at least one radially inner side of the toroidal support in order to form a filling insert structure.

Advantageously the working station 1 comprises two filler applying devices 8, 8′, as shown in FIG. 1. In this preferred embodiment, each of said two filler applying devices 8, 8′ is placed downstream a relevant assembling apparatus 3, 3′.

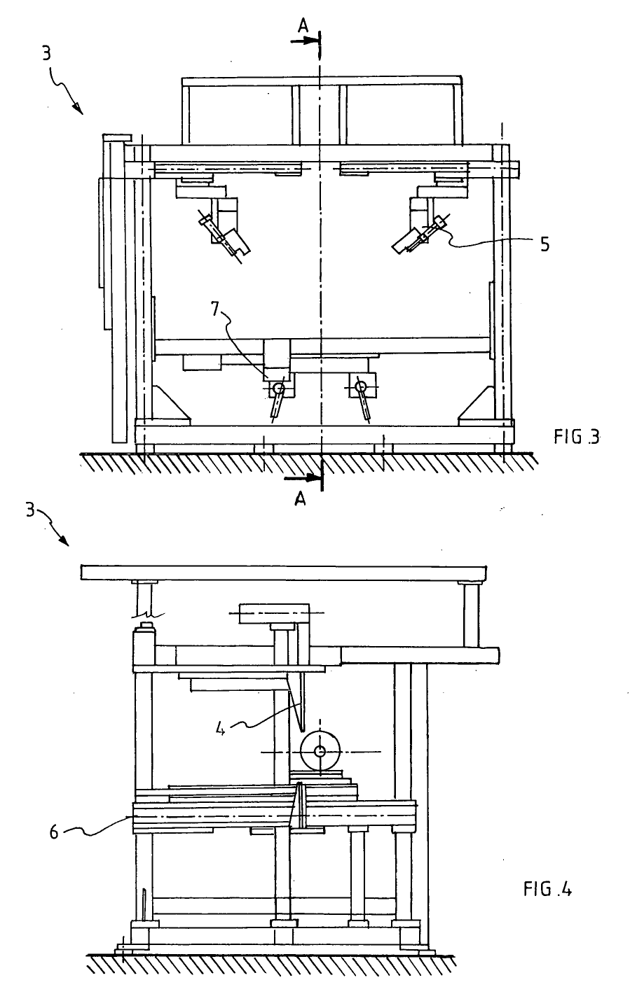

With reference to FIGS. 3 and 4, it is shown that the assembling apparatus 3, 3′ of the present embodiment of the invention comprises:
one strip laying device 4 adapted to form a carcass ply by laying a plurality of strip-like elements on side and crown portions of a toroidal support;
one annular reinforcing insert laying device 5 adapted to form an annular reinforcing insert by laying a plurality of coils of a first elongated element on at least one radially inner side of the toroidal support; and
one positioning device 6 adapted to position the toroidal support at one or the other of the strip laying device 4 and the annular reinforcing insert laying device 5.

Optionally the assembling apparatus 3, 3′ may comprise two or more strip laying devices 4, two or more annular reinforcing insert laying devices 5 and/or two or more positioning devices 6.

According to one embodiment of the present invention, the positioning device 6 of the assembling apparatus 3, 3′ comprises a sliding element which slides on suitable guides moving accordingly the toroidal support in different positions between the strip laying device 4 and the annular reinforcing insert laying device 5.

The assembling apparatus 3, 3′ of the preferred embodiment of the invention further comprises one or more cutting devices 7 adapted for suitably cutting said strip-like elements and comprising an upper cutting device and a lower cutting device.

When accomplishment of the carcass structure has been completed in the working station 1, that in the present embodiment belongs to the third working station 17, the fourth robotized arm 25 lays down the toroidal support on a third stand-by station 14″ that in the figure is engaged by toroidal support F.

A fifth robotized arm 26 picks up the toroidal support F from the third stand-by station 14″ to carry it to a fourth working station 18 that in the example shown is occupied by toroidal support E. In the fourth working station 18 manufacture and assembling of the structural components adapted to define the so-called belt structure of the tyre are carried out.

Further details on a possible modality for manufacture of the belt structure are described in WO 01/38077 in die name of the same Applicant.

When manufacture of the belt structure has been completed, the fifth robotized arm 26 transfers the tyre being processed to a fifth working station 19 that in the example shown is occupied by toroidal support D. In the fifth working station 19 the toroidal support D is engaged by a sixth robotized arm 27 with the aid of which application of a tread band is carried out, said tread band being obtained by winding up an elastomer ribbon-like element in coils disposed consecutively in side by side relationship and superposed until achievement of a tread band of the desired conformation and thickness.

The tyre is subsequently transferred to a sixth working station 20, occupied in this example by toroidal support C. In the sixth working station 20 the toroidal support C is engaged by a seventh robotized arm 28 causing appropriate handling of same in front of respective working apparatuses to carry out application of abrasion-resistant elements to the regions corresponding to the beads, as well as application of the sidewalls, which can be also obtained by winding up at least one elastomer band to form coils disposed in side by side and/or superposed relationship.

When this operation is over, the seventh robotized arm 28 lays down the manufactured tyre on an end stand-by station 14′″, occupied, in this example, by toroidal support B, before transfer of the tyre itself to the vulcanizing line 10.

Said vulcanizing line 10 advantageously comprises at least one series of vulcanization moulds 11 which are mounted on a turntable 30 to be driven in rotation in a step-by-step movement in the direction stated by arrow 31, so as to make the moulds carry out a closed-loop path along the vulcanizing line 10, sequentially carrying them, one after the other, to a loading-unloading station 32 of the tyres being processed.

With reference to the manufacturing plant 9 of FIG. 1, to the assembling apparatus 3, 3′ shown in FIGS. 2-4 and to the working station 1 of the building line 2 shown in FIG. 2, a preferred way of carrying out a process for producing tyres according to the invention, will be now better disclosed.

After the first tyre components have been assembled in the second working station 16, the process for producing tyres with a carcass structure comprising at least two carcass plies, each associated with at least a pair of annular reinforcing inserts, according to the present invention provides a first step i) of transferring a first toroidal support to a first assembling apparatus 3 of a working station 1 wherein the second step ii) is carried out.

Said second step ii) comprises the sequentially building on the first toroidal support of a first toroidal carcass ply and a first pair of annular reinforcing inserts so as to associate each annular reinforcing insert to a respective radially internal edge of the first toroidal carcass ply.

At this point, the first toroidal support is transferred to a second assembling apparatus 3′ (step iii)) wherein subsequent step iv) is carried out: a second toroidal carcass ply and a second pair of annular reinforcing inserts are sequentially built on the first toroidal support, carrying the first toroidal carcass ply associated with the first pair of annular reinforcing inserts, so as to associate each annular reinforcing insert to a respective radially internal edge of the second toroidal carcass ply.

While the first toroidal support is thus processed in the second assembling apparatus 3′, i.e. while step iv) is being carried out, a second toroidal support is transferred to the first assembling apparatus 3 (step v)) where a respective first toroidal carcass ply associated to a respective first pair of annular reinforcing inserts is built on said second toroidal support.

In other words two toroidal supports, subjected to different process steps, are processed simultaneously in the same working station 1.

Afterwards the process according to the present invention provides step vi) of completing the building of the tyre on the first toroidal support and then repeating the steps iv) and vi) on said second toroidal support in order to have also the tyre on the second toroidal support completed (step vii)).

Finally, the built tyres are subjected to a moulding and vulcanization step viii) which completes the tyre production process, as described above, in the vulcanizing line 10.

Preferably the steps from i) to vii) are repeated at least once. However the number of repetitions of said steps depends on the productivity needs.

The process, according to a preferred way of carrying out the invention, further comprises, between step ii) and step iv), the step of applying a first filler material on the first toroidal support carrying the first toroidal carcass ply associated with the first pair of annular reinforcing inserts.

Moreover, step vi) of completing the building of the tyre on the first toroidal support, according to one way of carrying out the invention, comprises applying a second filler material on the first toroidal support carrying the second toroidal carcass ply associated with the second pair of annular reinforcing inserts.

In case two filler applying devices 8, 8′ are provided, the first filler material may be different from the second filler material. This may be used for example to obtain final tyres with specific performing features.

Optionally at least one of said steps ii) and iv) is carried out by means of a positioning device 6 adapted to position the toroidal support in a position wherein a plurality of strip-like elements on side and crown portions of the toroidal support are laid, and in a position wherein a plurality of annular inserts on at least one radially inner side of the toroidal support are laid.

Preferably at least one of said steps i), iii), v) is carried out by means of a first transferring device 13 adapted to transfer the toroidal support from a building line 2 containing a working station 1 comprising the first assembling apparatus 3 and the second assembling apparatus 3′ into said working station 1 and vice versa and to transfer the toroidal support inside the working station 1, as mentioned above.

Alternatively one or more of said steps i), iii), v) are carried out by means of a first transferring device 13 and the remaining steps are carried out by means of a second transferring device 13′. For example step iii) is carried out by means of a first transferring device 13 and steps i) and v) are carried out by means of a second transferring device 13′.

In the scope of the present previous description and the following claims, all the numerical measurements indicating quantity, parameters, percentages, etc, are to be considered as preceded by the term “about”, unless otherwise specified. Furthermore, all the intervals of numerical measurement include all the possible combinations of the maximum and minimum numerical values, as well as all the possible intermediate intervals, as well as those specifically indicated in the text.

1-19. (canceled)

20. A process for producing tyres having a carcass structure comprising at least two carcass plies, each carcass ply being associated with at least a pair of annular reinforcing inserts, comprising the following steps:
i) transferring a first toroidal support to a first assembling apparatus;
ii) in the first assembling apparatus, sequentially building on the first toroidal support, a first toroidal carcass ply and a first pair of annular reinforcing inserts so as to associate each annular reinforcing insert with a respective radially internal edge of the first toroidal carcass ply;
iii) transferring the first toroidal support to a second assembling apparatus;
iv) in the second assembling apparatus, sequentially building on the first toroidal support, carrying the first toroidal carcass ply associated with the first pair of annular reinforcing inserts, a second toroidal carcass ply and a second pair of annular reinforcing inserts so as to associate each annular reinforcing insert with a respective radially internal edge of the second toroidal carcass ply;
v) transferring a second toroidal support to the first assembling apparatus to build thereon a respective first toroidal carcass ply associated with a respective first pair of annular reinforcing inserts, step v) being carried out when the first toroidal support is processed in the second assembling apparatus during step iv);
vi) completing the building of the tyre on said first toroidal support;
vii) repeating steps iv) and vi) on said second toroidal support; and
viii) moulding and vulcanizing the tyres.

21. The process according to claim 20, further comprising, between step ii) and step iv), a step of:
applying a first filler material on the first toroidal support carrying the first toroidal carcass ply associated with the first pair of annular reinforcing inserts.

22. The process according to claim 21, wherein step vi) comprises applying a second filler material on the first toroidal support carrying the second toroidal carcass ply associated with the second pair of annular reinforcing inserts.

23. The process according to claim 20, wherein at least one of said steps ii) and iv) is carried out by means of a positioning device adapted to position the toroidal support in a position wherein a plurality of strip-like elements on side and crown portions of the toroidal support are laid, and in a position wherein a plurality of annular inserts on at least one radially inner side of the toroidal support are laid.

24. The process according to claim 20, wherein at least one of said steps i), iii), and v) is carried out by means of a first transferring device adapted to transfer the toroidal support from a manufacturing line containing a working station comprising the first assembling apparatus and the second assembling apparatus into said working station and vice versa and to transfer the toroidal support inside the working station.

25. The process according to claim 20, wherein step iii) is carried out by means of a first transferring device, and steps i) and v) are carried out by means of a second transferring device.

26. The process according to claim 22, wherein the first filler material is different from the second filler material.

27. A tyre manufacturing line comprising at least one working station for assembling a carcass structure, comprising:
at least two assembling apparatuses of said carcass structure, each assembling apparatus comprising:
at least one strip laying device adapted to lay a plurality of strip-like elements on side and crown portions of a toroidal support in order to form a carcass ply;
at least one annular reinforcing insert laying device adapted to lay a plurality of coils of a first elongated element on at least one radially inner side of the toroidal support in order to form an annular reinforcing insert;
at least one transferring device to carry out at least one transferring step of the toroidal support selected from:
(i) a transferring step from the manufacturing line into the working station;
(ii) a transferring step inside the working station; and
(iii) a transferring step from the working station to the building line.

28. The tyre manufacturing line according to claim 27, wherein each of said assembling apparatuses comprises at least one positioning device adapted to position the toroidal support at one or the other of a strip laying device and an annular reinforcing insert laying device.

29. The tyre manufacturing line according to claim 27, wherein said working station comprises two transferring devices adapted to cooperate with each other.

30. The tyre manufacturing line according to claim 27, wherein a first transferring device comprises a robotized arm.

31. The tyre manufacturing line according to claim 29, wherein a second transferring device comprises a robotized arm.

32. The tyre manufacturing line according to claim 27, wherein said working station comprises at least one filler applying device adapted to lay a plurality of coils of a second elongated element on at least one radially inner side of the toroidal support in order to form a filling insert structure.

33. The tyre manufacturing line according to claim 32, wherein said working station comprises two filler applying devices.

34. An assembling apparatus for assembling at least a portion of a carcass structure, comprising:
at least one strip laying device adapted to lay a plurality of strip-like elements on side and crown portions of a toroidal support in order to form a carcass ply;
at least one annular reinforcing insert laying device adapted to lay a plurality of coils of a first elongated element on at least one radially inner side of the toroidal support in order to form an annular reinforcing insert; and
at least one positioning device adapted to operatively position the toroidal support alternatively at the strip laying device and at the annular reinforcing insert laying device.

35. The assembling apparatus according to claim 34, wherein the positioning device comprises a sliding element.

36. The assembling apparatus according to claim 34, further comprising at least one cutting device adapted for cutting said strip-like elements.

37. The assembling apparatus according to claim 36, wherein said cutting device comprises an upper cutting device and a lower cutting device.

38. A tyre manufacturing plant comprising a tyre manufacturing line according to claim 27, and a vulcanizing line.
